(19) United States
(12) Patent Application Publication
(10) Pub. No.: US 2011/0244253 A1
(43) Pub. Date: Oct. 6, 2011

(54) Device and Process for Molding a Custom Handle Grip and Measurement of Its Use

(76) Inventors: Josh Johnson, Long Beach, CA (US); Michael Vittone, San Pedro, CA (US)

(21) Appl. No.: 12/754,560

(22) Filed: Apr. 5, 2010

(51) Int. Cl. B32B 9/04; B28B 1/16; B65H 81/00

(52) U.S. Cl. 428/447; 425/2; 156/194

(57) ABSTRACT

A custom grip may be molded on a handle. Examples of handles that may benefit from a custom grip include baseball bats, hockey sticks, pool sticks, lacrosse sticks, tennis racquets, golf clubs and the like. The molding of the grip may be a combined synergy of thermal energy resulting from friction and electrical current flowing through a material that hardens in response to both thermal and electrical stimulus. This hardening process may occur while undergoing the dynamics that the end product experiences when in use by the intended user. The resulting handle may be both uniquely matched to the user's hands as well as his or her style of use.

### BACKGROUND OF THE INVENTION

The present invention relates to handle grips and, more particularly, to apparatus and methods for molding a custom grip on a handle.

Handles are provided on various pieces of equipment. For example, handles are provided on baseball bats, hockey sticks, pool sticks, lacrosse sticks, tennis racquets, golf clubs and the like. These handles are typically mass-produced as a one size fits all, or perhaps in a variety of preset sizes. These preset sizes may not adequately fit a user's hands.

A user may, for example, wrap a handle with tape to form a custom sized and shaped handle. These handles may be difficult to correctly size and may be even more difficult to produce more than one of the same size and shape.

As can be seen, there is a need for a custom grip on a handle that may be accurately reproduced.

### SUMMARY OF THE INVENTION

In one aspect of the present invention, a custom grip molding apparatus comprises electrical stimulator conductors adapted to wrap around at least a portion of a handle; a casting material adapted to coat at least a portion of the electrical stimulator conductors; and an electrical power supply data recorder electrically connectable to the electrical stimulator conductors.

In another aspect of the present invention, a custom grip for a handle, the custom grip formed by a process comprising the steps of gripping a casting material applied to the handle; and curing the casting material with a combination of heat and electrical current applied to the casting material.

In a further aspect of the present invention, a method for making a handle with a custom grip comprises wrapping at least a portion of the handle with electrical stimulator conductors; applying a casting material over at least a portion the electrical stimulator conductors; gripping the casting material; and curing the casting material with a combination of heat and electrical current applied to the casting material to provide the custom grip.

These and other features, aspects and advantages of the present invention will become better understood with reference to the following drawings, description and claims.

### BRIEF DESCRIPTION OF THE DRAWINGS

FIG. 1 is a side view of a baseball bat handle that may be used to mold a custom grip, according to an embodiment of the present invention;

FIG. 2 is a side view of the baseball bat handle of FIG. 1 having electrical stimulator conductors placed on the outer surface of the handle;

FIG. 3 is a schematic view of an electrical power supply and data recorder adapted to be electrically connected to the handle of FIG. 2;

FIG. 4 is an end view of the baseball bat handle of FIG. 2, showing an electrical inlet socket for connecting the electrical power supply and data recorder of FIG. 3; and

FIG. 5 is a side partial cross-sectional view of the baseball bat handle of FIG. 2 having molding putty applied thereto.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides apparatus and methods for molding a custom grip on a handle. Examples of handles that may benefit from a custom grip include baseball bats, hockey sticks, pool sticks, lacrosse sticks, tennis racquets, golf clubs and the like. The molding of the grip may be a combined synergy of thermal energy resulting from friction and electrical current flowing through a material that hardens in response to both thermal and electrical stimulus. This hardening process may occur while undergoing the dynamics that the end product experiences when in use by the intended user. The resulting handle may be both uniquely matched to the user's hands as well as his or her style of use.

During the molding process, as discussed below, conductors in and around the molding material may collect data. An electrical power supply data controller may be used to collect this data as well as deliver electrical current through the conductors. The data collected may be saved for use in the evaluation of the current and future use of the product. The molding process may result in a positive plug which may be utilized to form the final product. Should the final product become damaged (for example, a baseball bat breaks), the positive plug may be used to form a new baseball bat with the same custom handle grip.

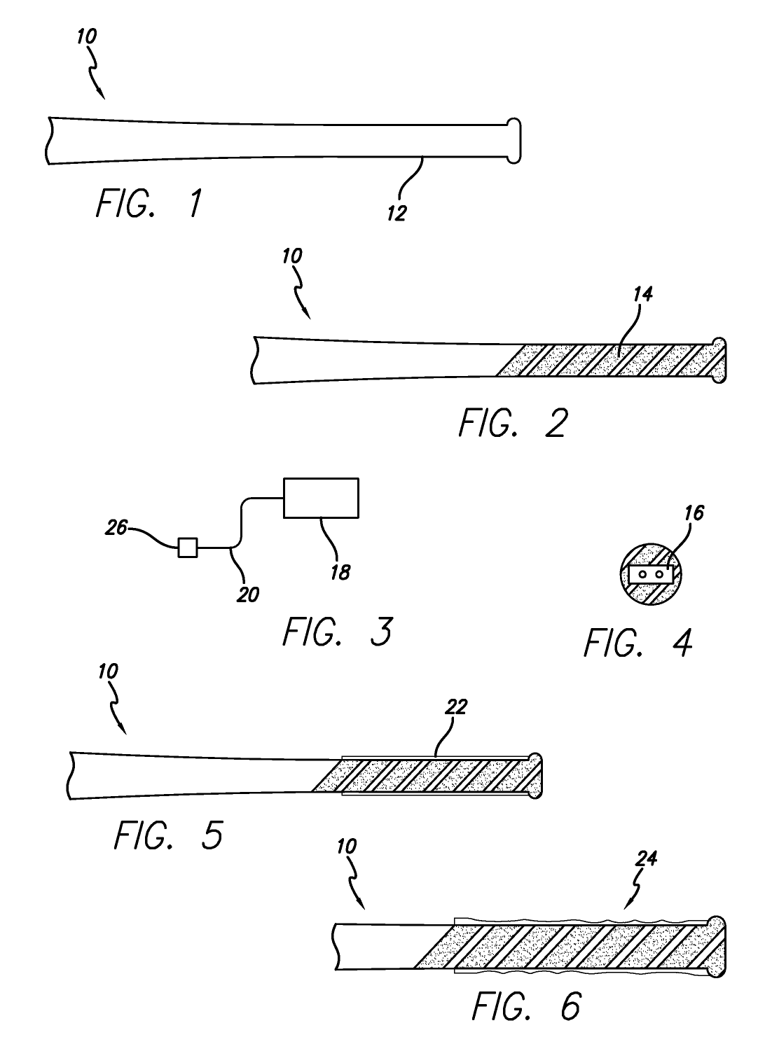

Referring to FIG. 1, a baseball bat mold base 10 may include a handle section 12 for which a custom grip may be designed. While the figures show an example of a baseball bat, any item for which a custom gripped handle may be advantageous can be used in the present invention.

The mold base 10 may simulate the desired end product by size and weight. For example, the baseball bat mold base 10 may have a size and shape similar to a conventional baseball bat. This may allow the user to grip the mold base 10, as discussed below, similar to how they would grip a regular baseball bat. In an alternate embodiment, the mold base 10 may be only a portion of the desired end product. For example, the mold base 10 may be only include the handle section 12 of the baseball bat.

As shown in FIG. 2, the handle section 12 may be wrapped with electrical stimulator conductors 14. These conductors may terminate at a terminal 16, as shown in FIG. 4. The terminal 16 may electrically connect with an electrical power supply data recorder 18, as shown in FIG. 3. A wire 20 may provide the electrical connection between the terminal 16 and the electrical power supply data recorder 18. The wire 20 may be a conventional copper wire, for example, having from 2 to about 10 conductors (not shown). The conductors may be used to deliver power to the electrical stimulator conductors 14.

The conductors of the wire 20 may also be used to receive data from the electrical stimulator conductors 14. The data received from the electrical stimulator conductors 14 may include data about the user's grip on the handle 12. The data may be interpreted by the electrical power supply data recorder 18 to provide a virtual grip profile based on the user's grip on the handle 12.

Referring now to FIG. 5, a casting material 22 may be applied to the handle 12, over the electrical stimulator conductors 14. The casting material 22 may be any suitable material that may conform to a user's grip on the handle. The casting material 22 may typically be a material that may harden with either or both of heat from the user's grip and/or electrical current delivered through the electrical stimulator conductors 14. The casting material 22 may be, for example, a layer of silicone putty material with a platinum catalyst.

In one embodiment of the present invention, the casting material 22 may include a putty formulated as a three part mixture. The first part (1A) of the mixture may include polyorganosiloxanes, amorphous silica, mineral oil and a platinum-siloxane complex. The second part (1B) of the mixture may include polyorganosiloxanes, amorphous silica and mineral oil. The third part (1C) may include aluminum shavings.

In one embodiment of the present invention, the casting material 22 may be from about 20-40% of the first part (1A), from about 20-40% of the second part (1B) and from about 20-40% of the third part (1C). Typically, approximately equal parts of the three components may be used, such as from about 30-36% of each of 1A, 1B and 1C. In one embodiment, equal parts of the three components 1A, 1B and 1C may be used to form the casting material 22.

The casting material 22 may have the ability to react and be cast and hardened by means of thermal and electrical energy. The thermal energy may be provided from the user's grip on the handle. The electrical energy may be provided from electrical current delivered from the electrical power supply data recorder 18, through wires 20 and into the electrical stimulator conductors 14.

The casting and hardening of the casting material 22 may result in a custom grip 24, as shown in FIG. 6. The custom grip 24 may be cast and hardened while the user is holding the casting material 22 with a grip intended for the action for which the device is intended. This action may include the analogous motion, swing, weight, inertia, rotational dynamics, momentum, angular velocities and friction encountered during the intended end use. For example, a baseball bat may be held with a desired grip for swinging the bat. In one embodiment, a user may actually perform the action for which the device is intended while the casting material 22 hardens.

The resulting custom grip 24 may be a positive plug which can be utilized to form the final product. In one embodiment, the resulting custom grip 24 may be scanned by a computer and used to form as a custom handle on a desired product. In another embodiment a tool, such as a lathe for example, may copy the custom grip 24 and form the custom grip 24 into a desired product. For example, a baseball bat may be formed using the positive plug formed from the custom grip 24. The custom grip 24 may be stored on the mold base 10. Alternatively, the custom grip 24 may be removed from the mold base 10 by, for example, cutting the casting material 22 lengthwise. The cut custom grip 24 may then be reconnected by, for example, an adhesive, and stored.

As discussed above, multiple desired products (i.e., baseball bats) may be made having the same custom grip 24. Data corresponding to the custom grip 24, or the positive plug of the custom grip 24 itself, may be saved and used for future products. For example, if a baseball player breaks their bat, a new bat may be produced without the need for the player to recast a grip into casting material.

According to another embodiment of the present invention, a method for making a handle with a custom grip is disclosed. The method may include a step of casting a custom grip on a handle by having a user grip a handle having a casting material applied thereto. The custom grip may be obtained during the ordinary use of the handle. The casting process may, as discussed above, be achieved by heat from a user's hand and/or electrical current delivered through the casting material. The method may further include a step of forming a handle by using a mold formed from the cured casting material.

The handle used for the casting process (for example, the handle section 12 of the baseball bat 10 of FIG. 1) may have a diameter smaller than the desired diameter of the end product. This smaller diameter may allow the electrical stimulator conductors 14 and the casting material 22 to be applied to the handle and still result in an end product that has a diameter suitable for the intended user. This diameter may vary between different end products, depending on the size of the user's hands and the grip used on the end product. For example, the way of holding a baseball bat may be different from the way of holding a golf club, thereby requiring different diameter grips.

It should be understood, of course, that the foregoing relates to exemplary embodiments of the invention and that modifications may be made without departing from the spirit and scope of the invention as set forth in the following claims.

We claim:

1. A custom grip molding apparatus comprising:
electrical stimulator conductors adapted to wrap around at least a portion of a handle;
a casting material adapted to coat at least a portion of the electrical stimulator conductors; and
an electrical power supply data recorder electrically connectable to the electrical stimulator conductors.

2. The custom grip molding apparatus of claim 1, further comprising a terminal for electrically connecting the electrical power supply data recorder to the electrical stimulator conductors.

3. The custom grip molding apparatus of claim 2, wherein the terminal is located in the end of the handle.

4. The custom grip molding apparatus of claim 1, wherein the electrical power supply data recorder is adapted to receive custom grip data from the electrical stimulator conductors.

5. The custom grip molding apparatus of claim 1, wherein the casting material is a material that hardens by at least one of heat, pressure and electrical current.

6. The custom grip molding apparatus of claim 1, wherein the casting material comprises:
a first part including polyorganosiloxanes, amorphous silica, mineral oil and a platinum-siloxane complex;
a second part including polyorganosiloxanes, amorphous silica and mineral oil; and
a third part including aluminum shavings.

7. The custom grip molding apparatus of claim 6, wherein the casting material comprises from about 20-40% of the first part, from about 20-40% of the second part and from about 20-40% of the third part.

8. The custom grip molding apparatus of claim 7, wherein the casting material comprises approximately equal parts of the first part, the second part and the third part.

9. The custom grip molding apparatus of claim 1, wherein the handle is shaped and sized similar to a desired end product.

10. The custom grip molding apparatus of claim 9, wherein the desired end product is selected from the group consisting of a baseball bat, a hockey stick, a pool stick, a lacrosse stick, a racquet, and a golf club.

11. A custom grip for a handle, the custom grip formed by a process comprising the following steps:
gripping a casting material applied to the handle; and
curing the casting material with a combination of heat and electrical current applied to the casting material.

12. The custom grip of claim 11, wherein the process further comprises:
wrapping at least a portion of the handle with electrical stimulator conductors; and
applying electrical current through the electrical stimulator conductors to cure the casting material.

13. The custom grip of claim 11, wherein the process further comprises shaping a desired end product handle with the custom grip shape designed in the curing step.

14. The custom grip of claim 11, wherein the casting material comprises:
a first part including polyorganosiloxanes, amorphous silica, mineral oil and a platinum-siloxane complex;
a second part including polyorganosiloxanes, amorphous silica and mineral oil; and
a third part including aluminum shavings.

15. The custom grip of claim 11, wherein the casting material comprises approximately equal parts of the first part, the second part and the third part.

16. A method for making a handle with a custom grip, the method comprising:
wrapping at least a portion of the handle with electrical stimulator conductors;
applying a casting material over at least a portion the electrical stimulator conductors;
gripping the casting material; and
curing the casting material with a combination of heat and electrical current applied to the casting material to provide the custom grip.

17. The method of claim 16, further comprising applying electrical current through the electrical stimulator conductors to cure the casting material.

18. The method of claim 17, further comprising operating the handle in the manner of intended use during the curing step.

19. The method of claim 16, further comprising shaping a desired end product handle with the custom grip shape designed in the curing step.
